(19) United States
(12) Patent Application Publication
(10) Pub. No.: US 2014/0156480 A1
(43) Pub. Date: Jun. 5, 2014

(54) PERSONAL FINANCIAL MANAGEMENT PAYMENT ALLOCATION

(71) Applicant: BANK OF AMERICA CORPORATION, Charlotte, NC (US)

(72) Inventors: Hood QAIM-MAQAMI, Montclair, NJ (US); Pavan CHAYANAM, Danville, CA (US); Rick KNAFELZ, Charlotte, NC (US)

(73) Assignee: BANK OF AMERICA CORPORATION, Charlotte, NC (US)

(21) Appl. No.: 13/690,117

(22) Filed: Nov. 30, 2012

(51) Int. Cl. G06Q 20/04

(52) U.S. Cl. CPC G06Q 20/04
USPC 705/35

(57) ABSTRACT

Devices, methods and computer program are defined that provide recommendations to users based on the user's personal financial management information and a benefit to the user. The personal financial management information may include a snapshot of the user's accounts, a timeline of the user's accounts, or a cash flow of the user's accounts. The benefit can be a financial benefit, such as a lower interest rate, or a non-financial benefit, such as an improved return policy. In a further embodiment, the recommendation is determined by crowdsourcing using a cohort of financial institution customers that share some characteristics with the user. As a result the user makes informed decisions on which payment type to use or other change for a future transaction at the merchant.

### FIELD

In general, embodiments herein disclosed relate to commerce and, more specifically, notifying users of a recommended payment method type for a future occurrence of a transaction based on analysis of the user's personal financial management information.

### BACKGROUND

Individuals conduct numerous transactions every day but have no way of no knowing whether these transactions are being made in an optimized manner. Often, when an individual starts a transaction using a specific payment method or in a specific manner, the individual continues to use the payment method or conducts the transaction in the earlier manner as a matter of habit.

Given the plethora of payment methods and options, even if individual desired to change the way a transaction proceeds, the individual would not know how to change the transaction such that the individual would receive a benefit. Even further, there is no way for the individual to determine whether a change would specifically benefit the individual based on the individual's specific financial situation.

Therefore, a need exists for making individuals aware of recommended payment methods and options for changing a transaction based on an analysis of the individual's financial information.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In a first aspect, a device configured for providing a recommendation for a future occurrence of a transaction is provided. In an embodiment, the device includes a computing platform including a memory and at least one processor in communication with the memory; and a payment recommendation module, stored in the memory, executable by the processor and configured to: determine that a user has conducted a transaction; determining personal financial management information for the user, the personal financial management information comprising at least one of a snapshot of at least one account of the user, a timeline of at least one account of the user, and a cash flow of at least one account of the user; determining a benefit to changing a future occurrence of the transaction; and providing a recommendation for the future occurrence of the transaction based on the personal financial management information and the benefit to changing.

In a further embodiment, the personal financial management information includes the snapshot, the timeline, and the cash flow for at least one account of the user. In some embodiments, the benefit to changing the future occurrence of the transaction is a non-financial benefit to the user. For example, the non-financial benefit may be selected from the group consisting of an extended warranty, an improved return policy, and access to a higher tier level of service. In other embodiments, the benefit to changing the future occurrence of the transaction is a financial benefit to the user. For example, the financial benefit may be selected from the group consisting of a low price guarantee, a lower interest rate, and a refund. In a still further embodiment, the benefit is determined based on a determination of the most frequent transaction method by a cohort of financial institution customers selected based on similarity to the user.

In a further aspect, a method for providing a recommendation for a future occurrence of a transaction is provided. In an embodiment, the method includes determining, by a computing device processor, that a user has conducted a transaction; determining, by a computing device processor, personal financial management information for the user, the personal financial management information comprising at least one of a snapshot of at least one account of the user, a timeline of at least one account of the user, and a cash flow of at least one account of the user; determining, by a computing device processor, a benefit to changing a future occurrence of the transaction; and providing a recommendation for the future occurrence of the transaction based on the personal financial management information and the benefit to changing.

In some embodiments, the personal financial management information includes the snapshot, the timeline, and the cash flow for at least one account of the user. In a further embodiment, the benefit to changing the future occurrence of the transaction is a non-financial benefit to the user. The non-financial benefit may be selected from the group consisting of an extended warranty, an improved return policy, and access to a higher tier level of service. In a still further embodiment, the benefit to changing the future occurrence of the transaction is a financial benefit to the user, such as a low price guarantee, a lower interest rate, and a refund. In an exemplary embodiment, the benefit is determined based on a determination of the most frequent transaction method by a cohort of financial institution customers selected based on similarity to the user.

In a still further aspect, a computer program product for providing a recommendation for a future occurrence of a transaction is provided. In an embodiment, the computer program product comprising a non-transitory computer-readable medium includes a set of codes for causing a device to determine that a user has conducted a transaction; a set of codes for causing a device to determine personal financial management information for the user, the personal financial management information comprising at least one of a snapshot of at least one account of the user, a timeline of at least one account of the user, and a cash flow of at least one account of the user; a set of codes for causing a device to determine a benefit to changing a future occurrence of the transaction; and a set of codes for causing a device to provide a recommendation for the future occurrence of the transaction based on the personal financial management information and the benefit to changing.

In some embodiments, the benefit to changing the future occurrence of the transaction is a non-financial benefit to the user, such as an extended warranty, an improved return policy, and access to a higher tier level of service. In further embodiments, the benefit to changing the future occurrence of the transaction is a financial benefit to the user, such as a low price guarantee, a lower interest rate, and a refund. In a still further embodiment, the benefit is determined based on a determination of the most frequent transaction method by a cohort of financial institution customers selected based on similarity to the user.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is an exemplary flow chart of a method of providing a recommendation for a future occurrence of a transaction, in accordance with one embodiment of the present invention;

FIG. 2 is a block diagram of an environment comprising a user device and a financial institution system for providing a recommendation for a future occurrence of a transaction, in accordance with one embodiment of the present invention;

FIG. 3 is a block diagram of a user device configured for providing a recommendation for a future occurrence of a transaction, in accordance with one embodiment of the present invention;

FIG. 4 is a block diagram of an environment wherein a system for providing a recommendation for a future occurrence of a transaction is being implemented, in accordance with one embodiment of the present invention; and

FIG. 5 is an exemplary embodiment of a screenshot of the user device configured for providing a recommendation for a future occurrence of a transaction, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, and the like and/or may not include all of the devices, components, modules and the like, discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Systems, methods, and computer program products are defined that provide for recommendations to a user for a future occurrence of a transaction in response to a determination that a user conducted a transaction at a merchant. The system may be implemented through a tablet computer or other user device. In one embodiment, the recommendation is based on personal financial management information of the user. The personal financial management information comprises at least one a snapshot of at least one account of the user, a timeline of at least one account of the user, and a cash flow analysis of at least on account of the user. In an exemplary embodiment, the personal financial information comprises the snapshot, the timeline, and the cash flow analysis. In some embodiments, the recommendation is based on the personal financial management information and is determined so that the future occurrence of the transaction provides a greater benefit to the customer and/or the financial institution than the previous transaction. The benefit may be a financial benefit, e.g., a lower interest rate, or it may be a non-financial benefit, e.g., an extended warranty or the like.

In some embodiments, the recommendation is to use a different payment method to conduct the transaction. For example, the system may determine that a new credit card provides additional purchase protections and recommends that the customer apply for the new credit card based on this benefit. In a further embodiment, the recommendation is to conduct the future occurrence of the transaction at a different merchant. For example, the financial institution may determine that fewer refunds occur when a customer conducts a transaction at Merchant B as opposed to Merchant A. Once the recommendation has been developed, the system provides the recommendation to the user and in some embodiments facilitates the transition from the previous transaction method to the recommended transaction method. In this regard, the present invention serves to make the customer aware of an option for a conducting a transaction that benefits the customer based on a holistic view of the customer's financial accounts.

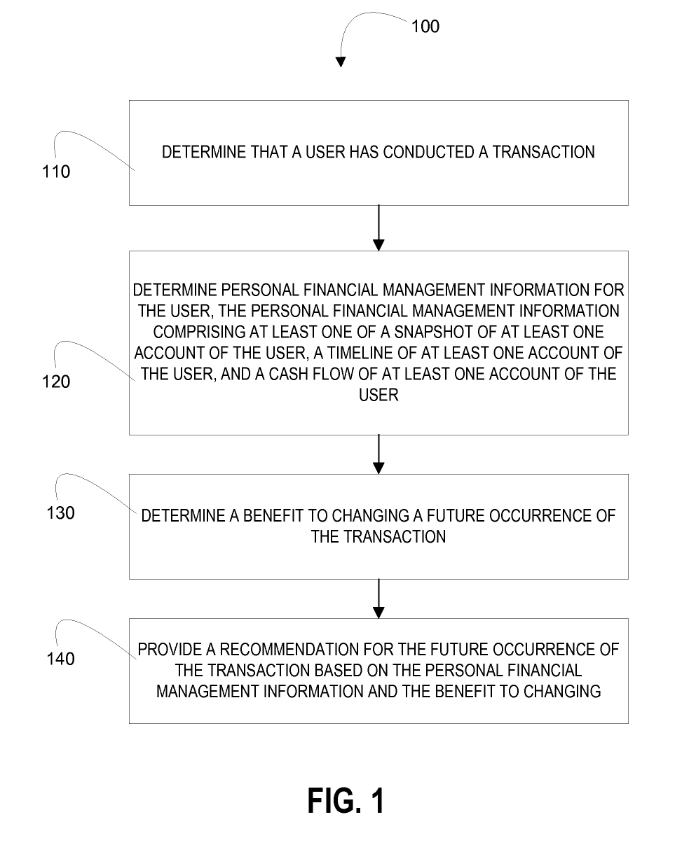

Referring to FIG. 1 a flow chart of a system and method for providing a recommendation for a future occurrence of a transaction is provided. In an embodiment, the system causes a computing device processor to determine that a user has conducted a transaction; determine personal financial management information for the user; determine a benefit to changing a future occurrence of the transaction; and providing a recommendation for the future occurrence of the transaction based on the personal financial management information and the benefit to changing. In some embodiments, the personal financial management information comprises at least one of a snapshot of at least one account of the user, a timeline of at least one account of the user, and a cash flow of at least one account of the user.

In block 110, the system determines that a user has conducted a transaction. In some embodiments, the user is a customer of a financial institution providing the personal financial management payment allocation system. For example the user may be a customer having a checking, a savings, and/or a credit card account with the financial institution. In this embodiment, the customer has a financial history with the financial institution. In further embodiments, however, the user is a new customer or a prospective customer of the financial institution. For example, the user may be a person that has recently established an account with the financial institution. In this embodiment, the user does not have an extended account history with the financial institution. In some embodiments, when the user does not have an extended account history with the financial institution, the system connects to secondary financial institutions to determine the personal financial management information of the user, as will be discussed. In a further embodiment, more than one user is able to combine accounts such that the system can provide recommendations based on all enrolled accounts for the more than one user. For example, a husband and wife may combine individual and joint accounts so that the system can evaluate the personal financial management information as a whole.

In some embodiments, the transaction is a credit, debit, transfer, or status check associated with an account of the user. For example, in an exemplary embodiment, the transaction is a purchase or payment by the user. The user may be paying for car insurance using a debit card. In another example, the transaction occurs through a third-party facilitator, such as a vendor that is implementing the financial institution's bill pay system. As mentioned, in some embodiments the transaction is merely a status check, such as a balance check at an ATM or a log-in at an online banking portal.

In an embodiment, the system determines that the user has conducted a transaction based on a record received of the transaction by the system. For example, the financial institution may receive a record from the merchant that the user has conducted or is conducting a transaction. The record may be an authorization request from the financial institution or a confirmation that the transaction has processed. In some embodiments, the device used during the transaction reports to the system that the user has conducted a transaction. For example, the user may be conducting a transaction, e.g., a purchase, using a mobile wallet on a mobile device. The mobile wallet may both conduct the transaction and report to the system that the user conducted the transaction.

In block 120, the system determines personal financial management information for the user. In some embodiments, the personal financial management information comprises at least one of a snapshot of at least one account of the user, a timeline of at least one account of the user, and a cash flow of at least one account of the user. The personal financial management information may be determined immediately after the system determines that the user has conducted a transaction, when the user accesses a program, e.g., an application or a review of the user's transaction history, on demand by the user, or on a regular or intermittent schedule. In one embodiment, the personal financial management information is updated continuously as the user conducts transactions. In another embodiment, the personal financial management information is updated when the user accesses a program configured to provide recommendations to the user.

In an embodiment, the personal financial management information comprises at least one of the snapshot, the timeline, and the cash flow of at least one of the user's accounts. In an exemplary embodiment, the personal financial management information comprises each of the snapshot, the timeline, and the cash flow of at least one of the user's accounts. It should be understood that the accounts analyzed for the snapshot, the timeline, and the cash flow information may be the same or different. The accounts may be all of the accounts that the user has with the financial institution or that the user has enrolled in the system.

The accounts may be a checking account, a savings account, a credit account, a loan account, a rewards point account, an investment account, or some other type of account having an amount capable of increasing or decreasing based on a transaction. In some embodiments, the account is with the financial institution hosting or providing the personal financial management payment allocation system. In further embodiments, the account is connected to the personal financial management payment allocation system over a network.

In an embodiment, a snapshot of at least one account of the user is a current record of the user's assets and liabilities. A snapshot provides a one-time view of the user's assets and liabilities as they currently exist across the accounts being analyzed by the system. The snapshot may capture the balance of any account (positive and negative), current information in the account (e.g., investments), and status (e.g., tier levels, rewards levels, and the like). In an embodiment, the snapshot also captures the difference between the user's current position and a target position. For example, the user may have a loan balance of $11,000. When the user reduces the loan balance to less than $10,000 the user may receive a lower interest rate. The difference between the current loan balance and the target loan balance is also a part of the snapshot.

In an embodiment, a timeline of at least one account of the user is a historical record of the user's transactions over a period of time. The timeline may be for a pre-determined period of time, a default period of time, a period of time selected by the user (e.g., selected when accessing the system, or set by the user previously), or for the entire time that records are available. In some embodiments, the timeline is the transaction history of the user. The timeline may be an exact record of the transaction of the user and/or it may be a summary of the transactions of the user. For example, the timeline may include both the exact transactions of the user as well as an aggregation of transactions for specific categories, such as groceries, utilities, and the like. In an exemplary embodiment, the timeline is used to determine how the user has conducted transactions including which merchants were used, how much was spent within specific default or user-defined categories, or the frequency of conducting specific types of transactions.

In an embodiment, a cash flow of at least one account of the user is a prediction of the user's transactions looking forward for a period of time. In an embodiment, the cash flow is based on historical records of transactions. For example, recurrent deposits and expenses can be modeled to predict the cash flow for a certain account or group of accounts into the future. In some embodiments, the user inputs the expected deposits, transfers, and expenses. In other embodiments, the system extracts the expected deposits, transfers, and expenses based on the user's transaction history.

It should be understood that other information may also be included in the personal financial management information. For example, user input information may be included in the personal financial management information, including without limitation the user's risk tolerance, the user's credit score, the user's financial goals, and the user's membership numbers if various loyalty programs. Also, information determined from the financial institution, such as demographic information, user tendencies, predictions based on comparison to similar demographic groups among the financial institution customers, and the like.

In block 130, the system determines a benefit to changing a future occurrence of the transaction. In an embodiment, the benefit is determined based on the personal financial management information for the user. For example, the system may determine that the user can benefit from changing the way the user pays for car insurance. A different payment method may provide rewards points for paying for the car insurance whereas the previous transaction did not provide the user rewards points. In an embodiment, the system analyzes payments data in the personal financial management information and determines that the user will benefit from changing the method of payment. It should be understood that the benefit can be financial or non-financial. Exemplary financial benefits include lower interest rates on loans, greater interest rates for savings, money back rewards, best price guarantees, and the like. Exemplary non-financial benefits include extended warranties, improved return policies, access to higher tier service levels, and the like.

In an embodiment, the system determines the benefit by analyzing the snapshot, the timeline, and the cash flow of the user. In a further embodiment, the system determines the benefit by comparing the current transaction of the user to similar transactions performed by other customers of the financial institution. The system may determine a profile of the user and compare that profile to the behavior of similar customers. In this manner, the system may “crowd-source” the determination of a beneficial method of making a transaction. This crowdsourcing of the determination for a benefit of a specific type of transaction is based on the concept that groups will, on average, utilize the most effective or cost-efficient means for conducting a transaction.

In some embodiments, however, transaction costs may inhibit a crowdsourcing solution to the determination of a more beneficial manner of making a transaction. For example, conducting a transaction with a specific type of mobile device may be most beneficial manner of conducting a transaction. There may be a barrier to determining this method based on crowdsourcing if the specific type of mobile device is expensive or rare and therefore not able to be used by the majority of customers conducting the transaction. Comparing the user to similarly situated customers of the financial institution may alleviate this issue because similar consumers may have similar products and face similar transaction costs. It should be understood, however, that the crowdsourcing of the most beneficial manner of conducting a transaction can be augmented by financial calculations made by the financial institution (e.g., interest rate differences and the like).

In one embodiment, the system crowdsources the determination of the more beneficial method of conducting the transaction based on an analysis of the user's social network connections. For example, the system may identify the user's social network connections and determine the method used most frequently by the user's social network connections for a similar transaction (e.g., a transaction at the same merchant or in the same category).

In some embodiments, the benefit is determined based on the benefit to the user and to the financial institution. For example, the user may benefit by using a bill pay system operated by the financial institution rather than a bill pay system operated by a third party vendor. Fees may be less, access to up-to-date bills and payments may be greater, and the user may find it more convenient to log into a single portal rather than log into multiple portals. Advantageously, the financial institution may also benefit based on increased customer service and relationships with the bill providers.

In an embodiment, the system comprises a learning functionality such that determination of benefits can be improved as the system is used. The learning functionality may be a machine learning algorithm or other algorithm for improving determination of benefits based on personal financial management information. In some embodiments, the learning functionality is based on the user's own actions. In a further embodiment, the learning functionality is based on an aggregate group, e.g., all individuals using the system or individuals sharing demographic characteristics of the user. In a still further embodiment, the learning functionality allows the determination of benefits to be improved based on input by the user. For example, the user may input that lower costs for transaction takes precedence of purchase protection and hence the system will weight recommendations that lower costs greater than recommendations that provide enhanced purchase protection.

In some embodiments, the system provides search functionality for the user. The user may be able to search for recent transactions that the system is able to provide recommendations for. For example, the user may search for recent transactions which the system determines could be changed such that the user saves a certain amount or percentage of the transaction. The search capability may be desirable when the user is evaluating the user's finances and determining how to improve the user's expenditures. The user may conduct a search for all grocery store transactions which the system determines could be conducted in a more beneficial manner. For example, the system may suggest paying for groceries using a credit card that offers a higher percentage of cash-back for use at grocery stores. By highlighting the previous transactions that the user did not use the credit card offering the higher percentage of cash back at grocery stores, the user is able to see where the user could be saving money and plan for future transactions at the store. The user may also search for recent transactions which the system determines could be changed such that the user would receive better non-financial benefits, e.g., return policies. The user may wish to do so when planning a future purchase that may be a gift so that the recipient of the gift find it easy to return the gift, if necessary.

In block 140, the system provides a recommendation for the future occurrence of the transaction based on the personal financial management information and the benefit to changing the future occurrence. The future occurrence may be a general occurrence, meaning it is not known or able to be predicted when the future occurrence will occur next, or the future occurrence may be planned. A planned future occurrence is a transaction that occurs on a regular schedule, e.g., weekly, monthly, annually, and the like.

In an embodiment, the system provides the recommendation through the device of the user. For example, the user may be using a tablet computer to evaluate the user's transaction history. As the user pulls up the user's transaction history, the system may cause a notice to be displayed to the user that a future occurrence of a specific transaction in the transaction history could be performed differently and result in a benefit to the user. In one embodiment, the recommendation is provided in general review areas for the user such as an online account register. In another embodiment, the recommendation is provided in a specialized area, such as a specialized webpage or region of an application on a tablet computer. It should be understood that the recommendation may be provided in other ways as well. For example, the recommendation can be emailed, texted to, or mailed to the user.

In further embodiments, the system implements the recommendation for the user. The system may receive an indication from the user that the user would like to take the recommendation. For example, the user may receive a recommendation to use a specific cash-rewards card for a type of transaction. The user may not have the cash-rewards card and therefore the system offers to submit an application for the user to the card. The system receives an affirmative response from the user and applies for the card on behalf of the user so that, if approved, the user can conduct a future occurrence of the transaction using the cash rewards card.

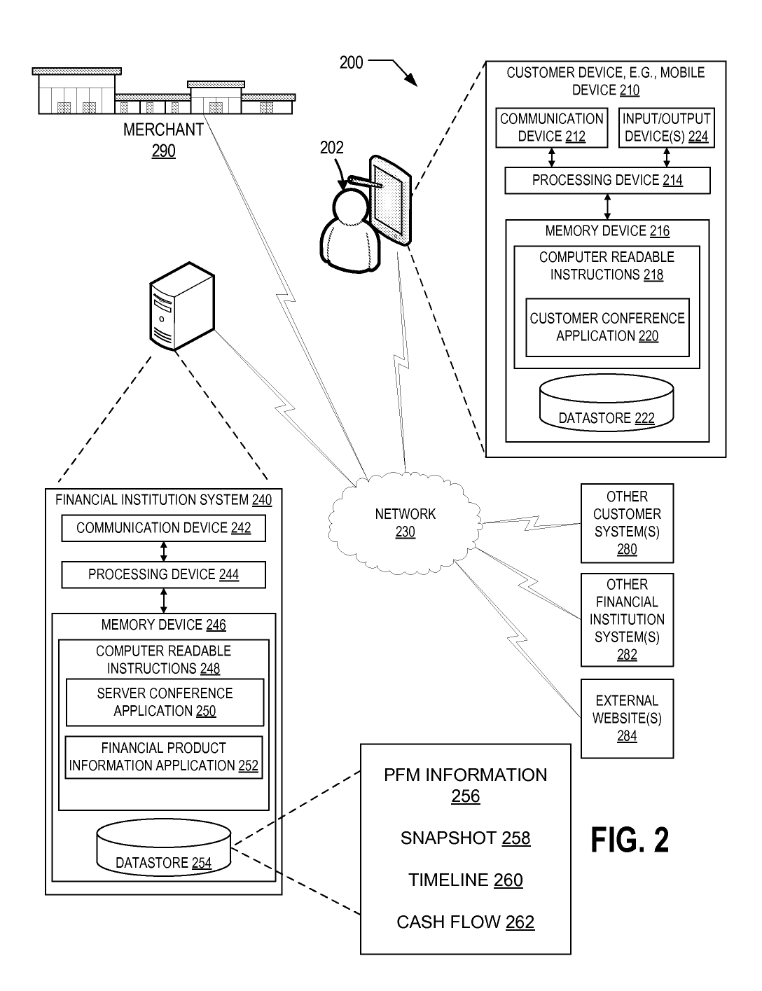

Referring now to FIG. 2, a block diagram illustrates an environment 200 wherein a user 202 conducts a transaction at a merchant 290. In an embodiment, the financial institution system 240 determines that the user 202 conducted a transaction at the merchant 290 and provides the user 202 with a recommendation for a future occurrence of the transaction using a customer device 210. The environment also may include other customer systems 280, other financial institution systems 282 and/or external websites 284. The systems and devices communicate with one another over a network 230 and perform one or more of the various steps and/or methods according to embodiments of the invention discussed herein.

A customer device 210 may be configured for use by a user 202 such as a customer, for example, to access one or more other financial institution applications such as the customer personal financial management application 220. The customer device 210 may be or include a computer system, server, multiple computer system, multiple servers, or some other computing device configured for use by a user, such as a tablet computer, a desktop, laptop, or a mobile communications device, such as a smartphone. The mobile device 210 has a communication device 212 communicatively coupled with a processing device 214, which is also communicatively coupled with a memory device 216 and one or more input and/or output devices 224, for example, an image capture device such as camera and/or a microphone. The processing device 214 is configured to control the communication device 212 such that the customer device 210 communicates across the network 230 with one or more other systems. The processing device 214 is also configured to access the memory device 216 in order to read the computer readable instructions 218, which in some embodiments include a customer personal financial management application 220. The memory device 216 also may have a datastore 222 or database for storing pieces of data for access by the processing device 214.

A financial institution system 240 is a computer system, server, multiple computer systems and/or servers or the like. The financial institution system 240, in the embodiments shown has a communication device 242 communicably coupled with a processing device 244, which is also communicably coupled with a memory device 246. The processing device 244 is configured to control the communication device 242 such that the financial institution system 240 communicates across the network 230 with one or more other systems. The processing device 244 is also configured to access the memory device 246 in order to read the computer readable instructions 248, which in some embodiments includes a server personal financial management application 250. The memory device 246 also has a datastore 254 or database for storing pieces of data for access by the processing device 244. In some embodiments, a financial product information application 252 retrieves information regarding financial products that may be of benefit to the user based on the user's personal financial management information.

In some embodiments, the datastore 254 includes the personal financial management (PFM) information 256 including at least one of the snapshot 258, the timeline 260, and the cash flow 262. The personal financial management information 256 may be updated regularly or at the request of the user 202. In an embodiment, records of the personal financial management information 256 are time-stamped such that the user may have a PFM information 256 record at time 1 and then a second PFM information 256 record at time 2, both of which may be stored in the datastore 254.

The applications 220 and 250 are for instructing the processing devices 214 and 244 to perform various steps of the methods discussed herein, and/or other steps and/or similar steps. In various embodiments, one or more of the applications 220 and 250 are included in the computer readable instructions stored in a memory device of one or more systems other than the systems 240 or device 210. For example, in some embodiments, the application 220 is stored and configured for being accessed by a processing device of one or more other customer systems 280 connected through network 230. In various embodiments, the applications 220 and 250 stored and executed by different systems/devices are different. In some embodiments, the applications 220 and 250 stored and executed by different systems may be similar and may be configured to communicate with one another, and in some embodiments, the applications 220 and 250 may be considered to be working together as a singular application despite being stored and executed on different systems. In some embodiments, the applications 220 and 250 stored and executed by the customer device and/or an application stored and executed on one of the other systems is a stand-alone application and does not necessarily communicate or rely on any other applications for data, processing or otherwise.

In various embodiments, one of the systems discussed above, such as the financial institution system 240, is more than one system and the various components of the system are not aggregated, and in various embodiments, there are multiple components performing the functions indicated herein as a single device. For example, in one embodiment, multiple processing devices perform the functions of the processing device 244 of the financial institution system 240 described herein. In various embodiments, the financial institution system 240 includes one or more of the other financial institution systems 282 and/or any other system or component used in conjunction with or to perform any of the method steps discussed herein.

In various embodiments, the financial institution system 240, the customer device 210, and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 100, the other methods discussed below, or other methods, processes or steps discussed herein or not discussed herein.

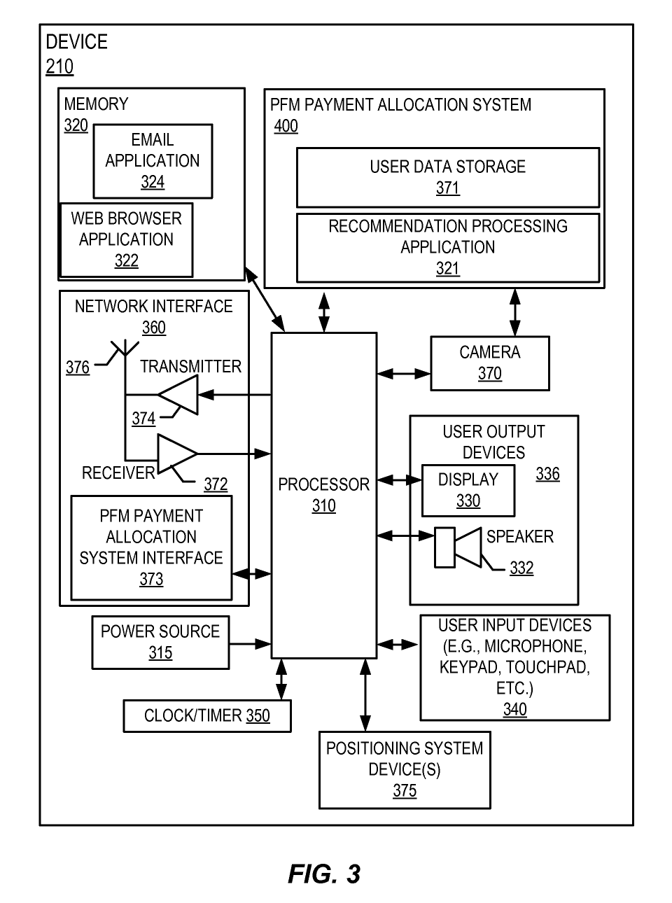

FIG. 3 illustrates an embodiment of a device 210 that may be configured with the personal financial management payment allocation system. In an embodiment, a “device” 210 is any mobile communication device, such as a cellular telecommunications device (i.e., a cell phone or mobile phone), personal digital assistant (PDA), smartphone, a mobile Internet accessing device, or other mobile device including, but not limited to portable digital assistants (PDAs), pagers, mobile televisions, gaming devices, laptop computers, tablet computers, cameras, video recorders, audio/video players, radios, GPS devices, and any combination of the aforementioned, or the like. The device 210 may also be stationary, such as a desktop computer, ATM, or financial institution kiosk, and provide access to the personal financial management functionality via a network 230.

The device 210 may generally include a processor 310 communicably coupled to such components as a memory 320, user output devices 336, user input devices 340, a network interface 360, a power source 315, a clock or other timer 350, a camera 370, at least one positioning system device 375, one or more personal financial management payment allocation systems 400, and the like. The processor 310, and other processors described herein, may generally include circuitry for implementing communication and/or logic functions of the device 210. For example, the processor 310 may include a digital signal processor device, a microprocessor device, and various analog to digital converters, digital to analog converters, and/or other support circuits. Control and signal processing functions of the device 210 may be allocated between these devices according to their respective capabilities. The processor 310 thus may also include the functionality to encode and interleave messages and data prior to modulation and transmission. The processor 310 may additionally include an internal data modem. Further, the processor 310 may include functionality to operate one or more software programs or applications, which may be stored in the memory 320. For example, the processor 310 may be capable of operating a connectivity program, such as a web browser application 322. The web browser application 322 may then allow the device 210 to transmit and receive web content, such as, for example, location-based content and/or other web page content, according to a Wireless Application Protocol (WAP), Hypertext Transfer Protocol (HTTP), and/or the like.

In some embodiments, the positioning system device 375 is configured to determine the location of the device. For example, at least one of the positioning system devices 375 may interact with the transceiver to send and/or receive information with wireless transmitters, such as GPS or Wi-Fi. In further embodiments, the positioning system device 375 is configured to determine movement and/or orientation of the mobile device. Accelerometers, magnetometers, and other devices can be included in the mobile device to provide information to the device on the location and velocity (speed and direction) of the device. Other types of positioning system devices 375 may be included in the device without limitation. For example, altimeters can be included in the device to determine the elevation of the device. Similarly, electronic or standard compasses may be included.

The processor 310 may also be capable of operating applications, such as a recommendation processing application 321. The recommendation processing application 321 may be downloaded from a server and stored in the memory 320 of the device 210. Alternatively, the recommendation processing application 321 may be pre-installed and stored in a memory of the personal financial management payment allocation system 400 or activated directly from a website operably linked to the device 210 through the network interface 360. In embodiments where the recommendation processing application 321 is pre-installed or run from a website, the user may not download the recommendation processing application 321 from a server.

The financial document processing system 400, as was discussed in greater detail in FIG. 2, may include the necessary circuitry to provide the personal financial management functionality to the device 210. Generally, the personal financial management payment allocation system 400 will include user data storage 371, i.e., a database, which may include data associated with the financial accounts. The personal financial management payment allocation system 400 and/or user data storage 371 may be an integrated circuit, a microprocessor, a system-on-a-chip, a microcontroller, or the like. As discussed above, in one embodiment, the personal financial management payment allocation system 400 provides the PFM information and recommendation functionality to the device 210.

Of note, while FIG. 3 illustrates the personal financial management payment allocation system 400 as a separate and distinct element associated with the device 210, it will be apparent to those skilled in the art that the personal financial management payment allocation system 400 functionality may be incorporated within other elements in the device 210. For instance, the functionality of the personal financial management payment allocation system 400 may be incorporated within the device memory 320 and/or the processor 310. In a particular embodiment, the functionality of the personal financial management payment allocation system 400 is incorporated in an element within the device 210 that provides PFM information analysis and recommendation capabilities to the device 210. Moreover, the functionality may be part of the firmware of the device 210. In some embodiments, the functionality is part of an application downloaded and installed on the device 210. Still further, the personal financial management payment allocation system 400 functionality may be included in a removable storage device such as an SD card or the like. In a still further embodiment, the personal financial management payment allocation system 400 may be available to the device 210 via a connection to the Internet, such as via a secure webpage or the like.

The processor 310 may be configured to use the network interface 360 to communicate with one or more other devices on a network. In this regard, the network interface 360 may include an antenna 376 operatively coupled to a transmitter 374 and a receiver 372 (together a “transceiver”). The processor 310 may be configured to provide signals to and receive signals from the transmitter 374 and receiver 372, respectively. The signals may include signaling information in accordance with the air interface standard of the applicable cellular system of the wireless telephone network that may be part of the network. In this regard, the device 210 may be configured to operate with one or more air interface standards, communication protocols, modulation types, and access types. By way of illustration, the device 210 may be configured to operate in accordance with any of a number of first, second, third, and/or fourth-generation communication protocols and/or the like. For example, the device 210 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The device 210 may also be configured to operate in accordance with non-cellular communication mechanisms, such as via a wireless local area network (WLAN) or other communication/data networks.

The network interface 360 may also include a personal financial management (PFM) payment allocation system interface 373 in order to allow a user to execute some or all of the above-described processes with respect to the recommendation processing application 321 and/or the personal financial management payment allocation system 400. The PFM payment allocation system interface 373 may have access to the hardware, e.g., the transceiver, and software previously described with respect to the network interface 360. Furthermore, the PFM payment allocation system interface 373 may have the ability to connect to and communicate with an external financial transaction processing system, such as a system that attaches to or wirelessly communicates with the device 210.

As described above, the device 210 may have a user interface that includes user output devices 336 and/or user input devices 340. The user output devices 336 may include a display 330 (e.g., a liquid crystal display (LCD) or the like) and a speaker 332 or other audio device, which are operatively coupled to the processor 310. The user input devices 340, which may allow the device 210 to receive data from a user 202, may include any of a number of devices allowing the mobile device 300 to receive data from a user 202, such as a keypad, keyboard, touch-screen, touchpad, microphone, mouse, joystick, stylus, other pointer device, button, soft key, and/or other input device(s).

The device 210 may further include a power source 315. Generally, the power source 315 is a device that supplies electrical energy to an electrical load. In one embodiment, power source 315 may convert a form of energy such as solar energy, chemical energy, mechanical energy, and such to electrical energy. Generally, the power source 315 in the device 210 may be a battery, such as a lithium battery, a nickel-metal hydride battery, or the like, that is used for powering various circuits, e.g., the transceiver circuit, and other devices that are used to operate the device 210. Alternatively, the power source 315 may be a power adapter that can connect a power supply from a power outlet to the device 210. In such embodiments, a power adapter may be classified as a power source “in” the device.

The device 210 may also include the memory 320 operatively coupled to the processor 310. As used herein, memory may include any computer readable medium configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory may additionally or alternatively include an electrically erasable programmable read-only memory (EEPROM), flash memory or the like.

The memory 320 may store any of a number of applications or programs which comprise computer-executable instructions/code executed by the processor 310 to implement the functions of the device 210 described herein. For example, the memory 320 may include such applications as a recommendation processing application 321, a web browser application 322, an SMS application, an email application 324, and the like.

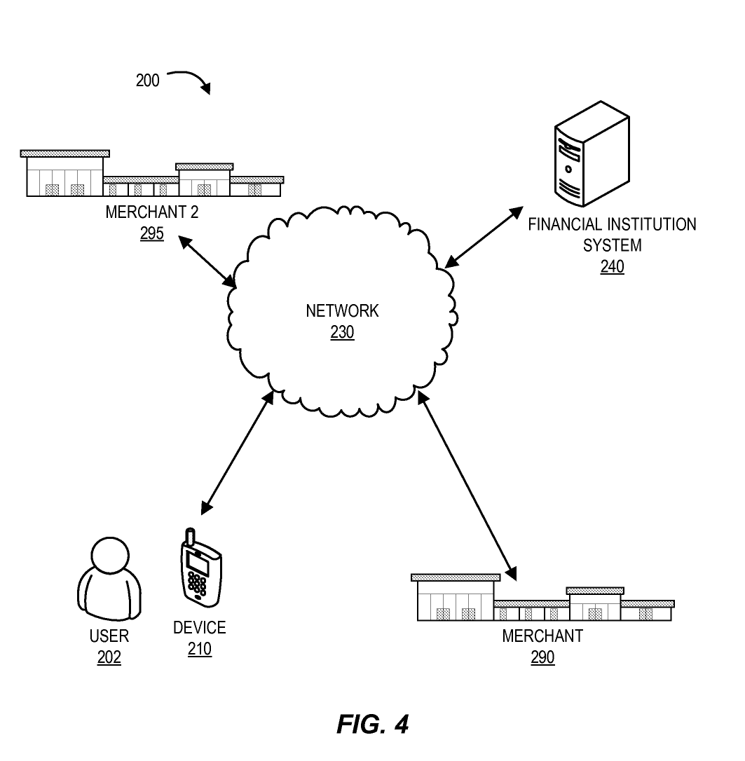

FIG. 4 is a block diagram of an environment wherein a system for providing a recommendation for a future occurrence of a transaction is being implemented, in accordance with embodiments of the present invention. In the environment 200, the user 202 conducts a transaction at a merchant 290. In some embodiments, the user 202 conducts the transaction using a user device 210. In some embodiments, the user 202 conducts the transaction using any type of payment method that can be captured by the provider of the system, e.g., credit card, debit card, check, or the like. After conducting the transaction, the system determines the user personal financial management information in coordination with the financial institution system 240. Using the personal financial management information of the user 202, the system 240 determines a recommendation for a future occurrence of the transaction. The recommendation may relate to a different payment method for the future transaction, such as using the device 210 instead of a credit card, or the recommendation may relate to a different merchant 295 for conducting the transaction. The device 210, the system 240, and the merchants 290, 295 may communicate over a network 230.

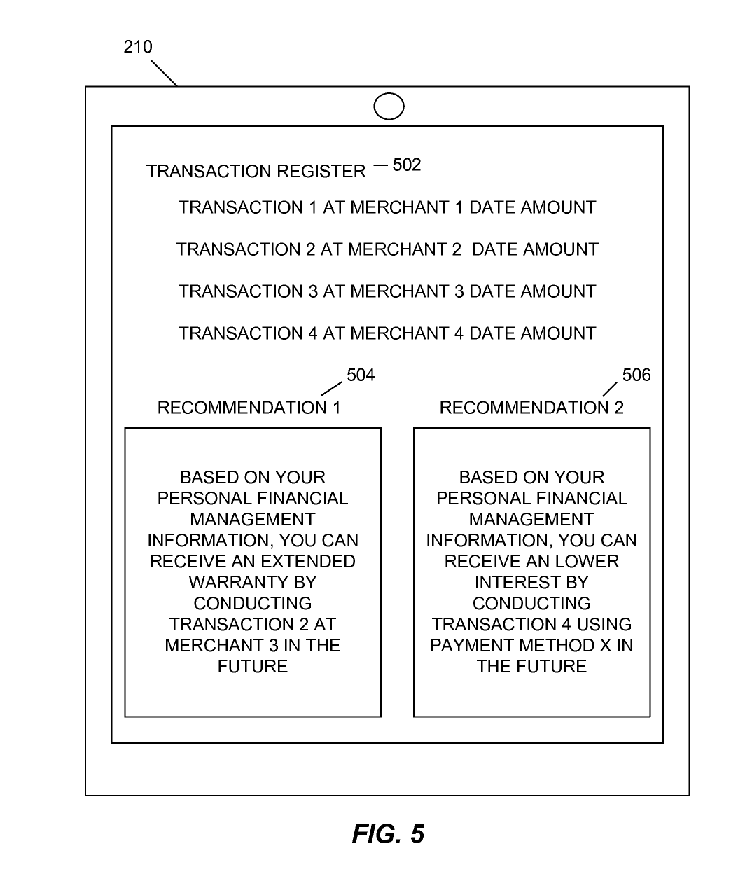

FIG. 5 is an exemplary embodiment of a screenshot of the user device 210 configured for providing a recommendation for a future occurrence of a transaction, in accordance with embodiments of the present invention. In an embodiment, the user device 210 is a tablet computer configured to access the user's financial account register 502. For example, the table computer may access the financial account register via a secure website or via a specialized application on the device. The transaction register 502 may include a history of the user's transactions, including information on the merchant, the date, and the amount of the transaction. Given at least one element of the personal financial management information, here the timeline of the user in the form of the transaction history, the system is able to determine a recommendation for a future occurrence of a transaction. In this example, the system is able to provide a first recommendation 504 that provides a non-financial benefit and a second recommendation 506 that provides a financial benefit.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A device configured for providing a recommendation for a future occurrence of a transaction, the device comprising:
a computing platform including a memory and at least one processor in communication with the memory; and
a payment recommendation module, stored in the memory, executable by the processor and configured to:
determine that a user has conducted a transaction;
determining personal financial management information for the user, the personal financial management information comprising at least one of a snapshot of at least one account of the user, a timeline of at least one account of the user, and a cash flow of at least one account of the user;
determining a benefit to changing a future occurrence of the transaction; and
providing a recommendation for the future occurrence of the transaction based on the personal financial management information and the benefit to changing.

2. The device of claim 1, wherein the personal financial management information comprises the snapshot, the timeline, and the cash flow for at least one account of the user.

3. The device of claim 1, wherein the benefit to changing the future occurrence of the transaction is a non-financial benefit to the user.

4. The device of claim 3, wherein the non-financial benefit is selected from the group consisting of an extended warranty, an improved return policy, and access to a higher tier level of service.

5. The device of claim 1, wherein the benefit to changing the future occurrence of the transaction is a financial benefit to the user.

6. The device of claim 5, wherein the financial benefit is selected from the group consisting of a low price guarantee, a lower interest rate, and a refund.

7. The device of claim 1, wherein the benefit is determined based on a determination of the most frequent transaction method by a cohort of financial institution customers selected based on similarity to the user.

8. A method for providing a recommendation for a future occurrence of a transaction, the method comprising:
determining, by a computing device processor, that a user has conducted a transaction;
determining, by a computing device processor, personal financial management information for the user, the personal financial management information comprising at least one of a snapshot of at least one account of the user, a timeline of at least one account of the user, and a cash flow of at least one account of the user;
determining, by a computing device processor, a benefit to changing a future occurrence of the transaction; and
providing a recommendation for the future occurrence of the transaction based on the personal financial management information and the benefit to changing.

9. The method of claim 8, wherein the personal financial management information comprises the snapshot, the timeline, and the cash flow for at least one account of the user.

10. The method of claim 8, wherein the benefit to changing the future occurrence of the transaction is a non-financial benefit to the user.

11. The method of claim 10, wherein the non-financial benefit is selected from the group consisting of an extended warranty, an improved return policy, and access to a higher tier level of service.

12. The method of claim 8, wherein the benefit to changing the future occurrence of the transaction is a financial benefit to the user.

13. The method of claim 12, wherein the financial benefit is selected from the group consisting of a low price guarantee, a lower interest rate, and a refund.

14. The method of claim 8, wherein the benefit is determined based on a determination of the most frequent transaction method by a cohort of financial institution customers selected based on similarity to the user.

15. A computer program product for providing a recommendation for a future occurrence of a transaction, the computer program product comprising a non-transitory computer-readable medium comprising:
a set of codes for causing a device to determine that a user has conducted a transaction;
a set of codes for causing a device to determine personal financial management information for the user, the personal financial management information comprising at least one of a snapshot of at least one account of the user, a timeline of at least one account of the user, and a cash flow of at least one account of the user;
a set of codes for causing a device to determine a benefit to changing a future occurrence of the transaction; and
a set of codes for causing a device to provide a recommendation for the future occurrence of the transaction based on the personal financial management information and the benefit to changing.

16. The computer program product of claim 15, wherein the benefit to changing the future occurrence of the transaction is a non-financial benefit to the user.

17. The computer program product of claim 16, wherein the non-financial benefit is selected from the group consisting of an extended warranty, an improved return policy, and access to a higher tier level of service.

18. The computer program product of claim 15, wherein the benefit to changing the future occurrence of the transaction is a financial benefit to the user.

19. The computer program product of claim 18, wherein the financial benefit is selected from the group consisting of a low price guarantee, a lower interest rate, and a refund.

20. The computer program product of claim 15, wherein the benefit is determined based on a determination of the most frequent transaction method by a cohort of financial institution customers selected based on similarity to the user.
